(19) United States
(12) Patent Application Publication
(10) Pub. No.: US 2015/0221271 A1
(43) Pub. Date: Aug. 6, 2015

(54) DISPLAY DEVICE

(71) Applicant: Samsung Display Co., Ltd., Yongin-City (KR)

(72) Inventors: Jun-Ho HWANG, Asan-si (KR); Heebum PARK, Seongnam-si (KR); Kihyun PYUN, Gwangmyeong-si (KR)

(21) Appl. No.: 14/460,166

(22) Filed: Aug. 14, 2014

(30) Foreign Application Priority Data
Feb. 4, 2014 (KR) 10-2014-0012711

(51) Int. Cl. G09G 3/36

(52) U.S. Cl. CPC G09G 3/3655; G09G 3/3688; G09G 2300/0842; G09G 2310/0291; G09G 2300/0426

(57) ABSTRACT

Provided is a display device. The display device includes a display panel including a common voltage generator generating an output voltage to be provided to the plurality of pixels. Each of the plurality of pixels includes a pixel electrode receiving a data voltage, a common electrode receiving the output voltage through common voltage lines, and a liquid crystal capacitor charged with a voltage difference between the data voltage and the output voltage. The common voltage generator compensates the output voltage based on a ratio of an internal resistance of the common voltage generator to a resistance component of the common electrode disposed on the display panel and outputs the compensated output voltage.

### CROSS-REFERENCE TO RELATED APPLICATIONS

This U.S. non-provisional patent application claims priority under 35 U.S.C. §119 to Korean Patent Application No. 10-2014-0012711, filed on Feb. 4, 2014, the entire contents of which are hereby incorporated by reference.

### BACKGROUND

The present disclosure herein relates to a display device, and more particularly, to a display device improving display quality of a display panel by controlling a common voltage.

Liquid crystal displays (LCD) are injected with a liquid crystal material having an anisotropic dielectric constant between two substrates. An electric field is applied to the liquid crystal material and the strength of the electric field is controlled, thereby controlling an amount of light penetrating the substrates. As a result thereof, a desired image signal is displayed on an LCD.

Respective pixels of an LCD include red, green, and blue subpixels whose optical transmittance is controlled by a voltage difference between a pixel voltage which corresponds to a data voltage and a common voltage. A storage capacitor in the subpixels is charged with the voltage difference and the liquid crystal layer maintains its transmittance during a predetermined time period by the storage capacitor. Thin film transistor, in response to a gate voltage supplied to a gate line, charges the pixel electrode with the data voltage supplied from a data line.

### SUMMARY

The present disclosure provides a display device increasing in driving reliability and a method of driving the display device.

Embodiments of the inventive concept provide display devices including a display panel including a plurality of pixels and a common voltage generator generating an output voltage to be provided to the plurality of pixels. Herein, each of the plurality of pixels includes a pixel electrode receiving a data voltage, a common electrode receiving the output voltage through common voltage lines, and a liquid crystal capacitor charged with a voltage difference between the data voltage and the output voltage. Also, the common voltage generator compensates the output voltage based on a ratio of an internal resistance of the common voltage generator to a resistance component of the common electrode disposed on the display panel and outputs the compensated output voltage.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram illustrating a display device according to an embodiment of the inventive concept;

FIG. 2 is a schematic top view of the display panel of FIG. 1;

FIG. 3 is a circuit diagram illustrating a way of providing or receiving a common voltage between a common voltage generator and a common electrode;

FIG. 4 illustrates an example of generating a common voltage compensated by the common voltage generator shown in FIG. 3; and

FIG. 5 is a schematic top view of the display panel of FIG. 1.

### DETAILED DESCRIPTION OF THE EMBODIMENTS

Since embodiments of the inventive concept may have various modifications and several shapes, exemplary embodiments will be shown in the drawings and will be described in detail. However, this is not to limit the inventive concept to the exemplary embodiments but should be understood as including all modifications, equivalents, and substitutes included in the spirit and the scope of the inventive concept.

While describing the respective drawings, like reference numerals designate like elements. In the attached drawings, sizes of structures are more enlarged than they actually are for clarity of the inventive concept. Although terms such as a first, a second, etc. may be used to describe various elements, the elements are not limited to the terms used. The terms are used merely to distinguish one element from another. For example, within the scope of the inventive concept, a first component may be designated as a second component, and similarly, the second component may be designated as the first component. A singular form, unless defined otherwise in contexts, may include a plural form.

In the present specification, terms of “comprise” or “have” are used to designate features, numbers, steps, operations, elements, components or combinations thereof disclosed in the specification as being present but not to exclude possibility of the existence or the addition of one or more other features, numbers, steps, operations, elements, components, or combinations thereof.

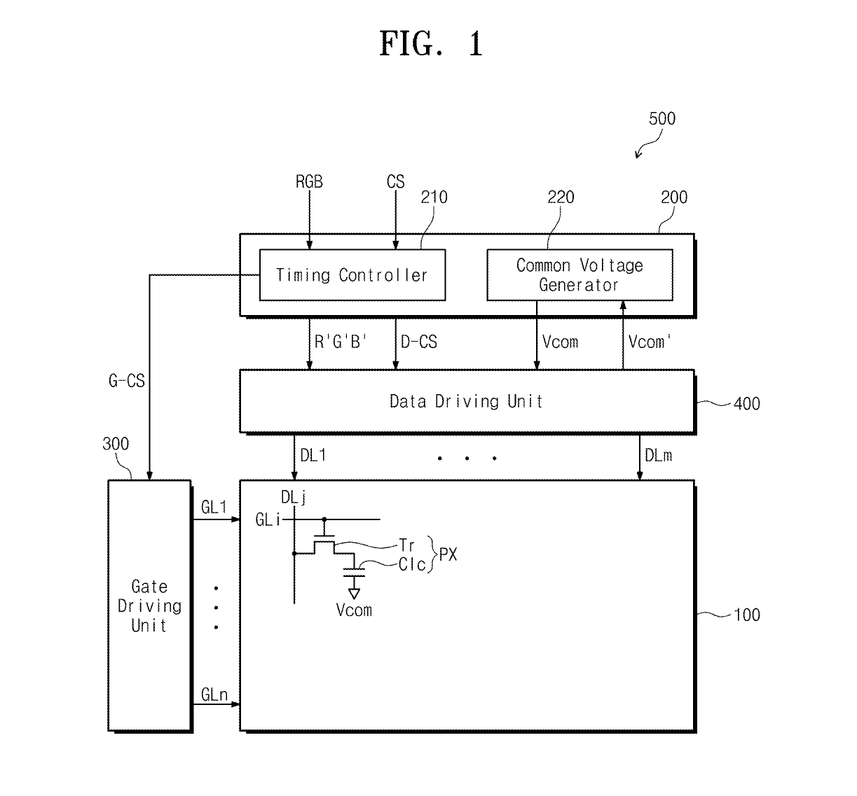

FIG. 1 is a block diagram of a display device 500 according to an embodiment of the inventive concept.

Referring to FIG. 1, the display device 500 includes a display panel 100, a printed circuit board 200, a gate driving unit 300, and a data driving unit 400.

The display panel 100 includes a plurality of pixels PX. In FIG. 1, for brief description, there are shown only one of the pixels PXs, one gate line GLi of a plurality of gate lines GL1 to GLn connected to the pixels PXs, and one data line DLj of a plurality of data lines DL1 to DLm. Herein, n and m are integers greater than 0. Also, i is an integer greater than 0 and equal to n or less. Also, j is an integer greater than 0 and equal to m or less. However, actually, the gate lines GL1 to GLn and the data lines DL1 to DLm are disposed on the display panel and are connected to corresponding pixels PXs, respectively. Herein, the pixels PXs may be arranged as a matrix.

The plurality of gate lines GL1 to GLn may extend in a line direction to intersect with the plurality of data lines DL1 to DLm which extend in a row direction. A pixel PX is connected to the corresponding gate line GLi and the corresponding data line DLj.

In detail, the pixel PX connected to the gate line GLi and the data line DLj includes a thin film transistor Tr and a liquid crystal capacitor Clc connected to the thin film transistor Tr. The thin film transistor Tr includes a gate electrode connected to the gate line GLi, a source electrode connected to the data line DLj, and a drain electrode connected to a liquid crystal capacitor Clc. Although not shown in the drawing, other pixels have the same configuration as the pixel PX.

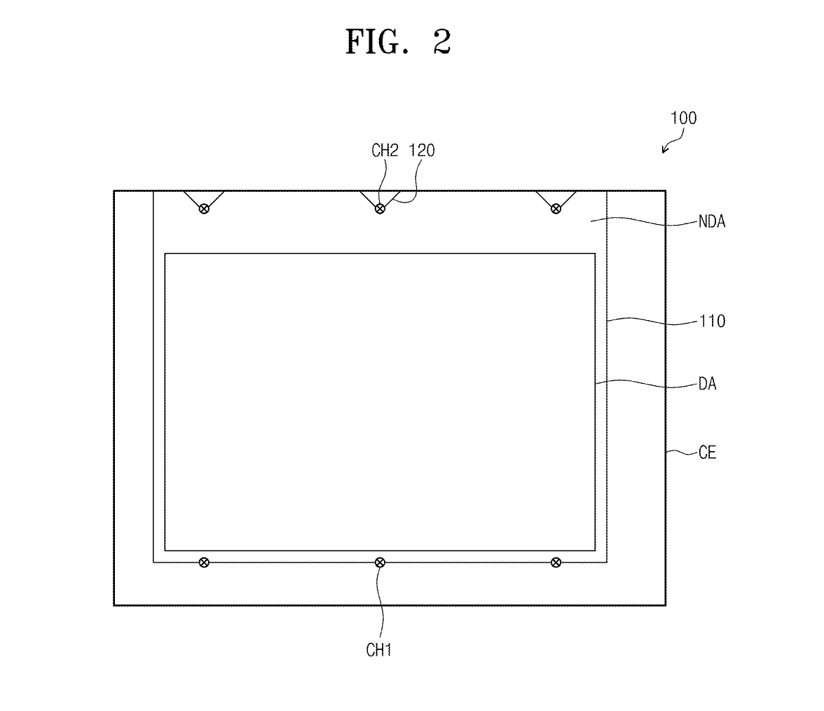

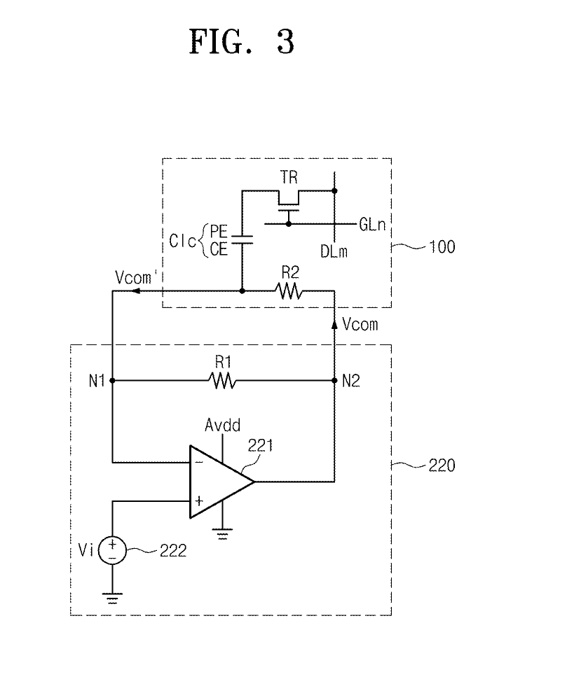

Also, the liquid crystal capacitor Clc consists of a pixel electrode (refer to FIG. 3) electrically connected to a drain electrode of the thin film transistor Tr, a common electrode (refer to FIG. 2) opposite to the pixel electrode, and a liquid crystal layer (not shown) disposed between the pixel electrode and the common electrode. The liquid crystal capacitor Clc may be charged with a voltage difference between a data voltage supplied to the pixel electrode and an output voltage of the common voltage generator Vcom (hereafter “output voltage”) supplied to the common electrode.

On the other hand, a ripple may occur in the output voltage Vcom supplied to the common electrode. A ripple component included in the output voltage Vcom described above may occur due to a coupling phenomenon when driving of the display panel 100. As a result, the voltage applied to the liquid crystal, the voltage difference between the pixel electrode and the output voltage Vcom, may vary and horizontal crosstalk may occur on the display panel 100. Thus, overall displaying properties of the display device 500 may become degraded.

The display device 500 according to the inventive concept provides the display panel 100 with the output voltage Vcom compensated based on a feedback voltage from the output of the amplifier Vcom′ (hereafter “feedback voltage”). Hereafter the feedback voltage Vcom′ will be explained as a ripple. Also, the feedback voltage Vcom′ will be explained as AC voltage. For this, the display panel 100 provides a common voltage generator 220 with the feedback voltage Vcom′ through the data driving unit 300.

The printed circuit board 200 may include a timing controller 210 and the common voltage generator 220.

The timing controller 210 receives a plurality of image signals RGB and a plurality of control signals CS from outside of the display device 500. The timing controller 210, in response to the image signals RGB, converts data formats of the image signals RGB corresponding to interface specifications. Image signals R′G′B′ with converted data formats are provided to the data driving unit 300.

Also, the timing controller 210, in response to the control signals CS, generates a gate control signal G-CS and a data control signal D-CS. The timing controller 210 provides the gate driving unit 300 with the gate control signal G-CS and provides the data driving unit 300 with the data control signal D-CS.

The common voltage generator 220 generates the output voltage Vcom to be provided to the display panel 100. The common voltage generator 220 may provide the display panel 100 with the output voltage Vcom through the data driving unit 300. Also, the common voltage generator 220 may receive the feedback voltage Vcom′ outputted from the display panel 100 through the data driving unit 400.

In the embodiment, the common voltage generator 220 generates the output voltage Vcom compensated based on the feedback voltage Vcom′.

A conventional common voltage generator generates a compensated common voltage only based on the common voltage including the ripple. When the compensated common voltage is provided to a common electrode of a display panel, the compensated common voltage may be distorted by a resistant component of the display panel. Herein, the resistant component of the display panel may be a resistant component of a common electrode and a common voltage line electrically connected to the common electrode. Accordingly, a distorted common voltage may be applied to the common electrode disposed on the display panel. In this case, pixels of the display panel may not display normal images due to a distorted common voltage. As a result, display property of the display panel is deteriorated.

In the embodiment, when compensating the feedback voltage Vcom′, the common voltage generator 220 generates the output voltage Vcom compensated referring to resistant components of the common electrode (refer to FIG. 2) and the common voltage line (refer to FIG. 2) included in the display panel 100. It will be described in detail with reference to FIG. 3. On the other hand, the common voltage generator 220 may generate the output voltage Vcom referring to the resistant component of the common voltage line but the method of generating the output voltage is not limited thereto. For example, the common voltage generator 220 may generate the output voltage Vcom referring to the resistant component of the common electrode disposed on the display panel 100.

Also, not shown in FIG. 1, one of the feedback voltage Vcom′ and the compensated output voltage may be transmitted to one of the common voltage generator 220 and the display panel 100 through the common voltage line electrically connecting the data driving unit 400 and the display panel 100 to each other.

The gate driving unit 300, in response to the gate control signal G-CS provided from the timing controller 210, sequentially outputs a plurality of gate signals. The gate driving unit 300 may provide the pixels PXs disposed on the display panel 100 with the gate signals through the gate lines GL1 to GLn. The pixels PXs may be sequentially scanned line by line in response to the gate signals.

The data driving unit 400, in response to the data control signal D-CS provided from the timing controller 210, converts the image signals R′G′B′ into data voltages. The data driving unit 400 provides the pixels PXs disposed on the display panel 100 with the data voltages converted from the image signals R′G′B′. The pixels PXs, in response to the gate signals, receive the data voltages and display images corresponding to the data voltages. As a result thereof, images may be displayed by the pixels PXs.

FIG. 2 is a schematic top view of the display panel 100 of FIG. 1.

Referring to FIG. 2, the display panel 100 includes first and second common voltage lines 110 and 120, a display area DA including the pixels (refer to FIG. 1), a non-display area NDA including the first and second common voltage lines 110 and 120, and a common electrode CE covering a top of the display area DA. Herein, the non-display area NDA may be defined as an area except the display area DA. Also, an area of the common electrode CE may be greater than the display area DA and may overlap the non-display area NDA.

The display area DA is an area for displaying an image when an electric signal is applied. The display area DA may include the pixels PXs.

The first common voltage line 110 is disposed in a periphery of the display area DA, that is, in the non-display area NDA. As an example, the first common voltage line 110, as shown in FIG. 2, is disposed adjacently to left, right, and lower boundaries of the display area DA in which pads for a data driver is not disposed and is electrically connected to each other. However, the first common voltage line 110 is not limited thereto and may be disposed at the upper boundary in which pads for a data driver IC is disposed, The data driver unit may include a common voltage node connected to the first and the second common voltage lines the display panel.

Also, the first common voltage line 110 may include at least one first contact hole CH1. As shown in FIG. 2, a plurality of first contact holes CH1 may be disposed on the first common voltage line 110 disposed below the display area DA with predetermined intervals. The output voltage Vcom outputted from the common voltage generator 220 may be provided to the first common voltage line 110. The first common voltage line 110 is electrically connected to the common electrode CE through the first contact hole CH1. Accordingly, the output voltage Vcom may be provided to the common electrode CE through the first common voltage line 110. That is, the first contact hole CH1 may be a contact hole electrically connecting the first common voltage line 110 to the common electrode CE.

The second common voltage line 120 may be disposed at least one on a top boundary of the periphery of the display area DA in which the data driver 400 is electrically connected to the display panel 100, that is, on the non-display area NDA. Herein, the second common voltage lines 120 may extend from the data driving unit 400 and may be disposed in the non-display area NDA.

The second common voltage line 120 is electrically connected to the common electrode CE through a second contact hole CH2. The output voltage Vcom outputted from the common voltage generator 220 may be provided to the second common voltage line 120. The output voltage Vcom provided to the second common voltage line 120 may be provided to the common electrode CE through the second contact hole CH2. That is, the second contact hole CH2 may be a contact hole electrically connecting the second common voltage line 120 to the common electrode CE.

The first common voltage line 110 and the second common voltage line 120 may be disposed on the same level. However, not limited thereto, the first and second common voltage lines 110 and 120 may be disposed on different levels.

FIG. 3 is a circuit diagram illustrating a way of providing or receiving a common voltage between the common voltage generator 220 and the common electrode CE.

Referring to FIG. 3, the common voltage generator 220 receives the feedback voltage Vcom′ from the common electrode CE disposed in the display panel 100. As described above, a ripple component, that is the feedback voltage Vcom′ may be generated by a coupling phenomenon when driving the display panel 100. The common voltage generator 220 generates the output voltage Vcom to be provided to the common electrode CE using the received feedback voltage Vcom′.

That is, the common voltage generator 220 generates the output voltage Vcom compensated based on the feedback voltage Vcom′ received from the common electrode CE and provides the compensated output voltage to the common electrode CE.

In detail, the common voltage generator 220 includes a first resistor R1, an amplifier 221, and a reference voltage source 222. A first input terminal, an inverting input (“−”), of the amplifier 221 is electrically connected to one node of the first resistor R1, the common electrode CE and one node of a second resistor R2 disposed on the display panel 100 through a first node N1. A second input terminal, a non-inverting input (“+”), of the amplifier 221 is connected to one end of the reference voltage source 222, and another end of the reference voltage source 222 is connected to a ground GND. Also, an output terminal of the amplifier 221 is connected to another node of the first resistor R1 and another node of the second resistor R2 through a second node N2.

The feedback voltage Vcom′ is received at the—inverting input of the amplifier 221 through the first node N1. A reference voltage Vi provided from the reference voltage source 222 is provided to the non-inverting input of the amplifier 221. For example, the reference voltage Vi may be a direct current (DC) voltage. Also, the amplifier 221 is previously set with a positive supply voltage Avdd and a negative supply voltage GND. The amplifier 221 outputs the output voltage Vcom compensated based on the maximum voltage Avdd and the ground voltage GND. The compensated output voltage may be provided to the common electrode CE through the second node N2.

Also, the display panel 100 includes a thin film transistor TR, a liquid crystal capacitor Clc connected to the thin film transistor TR, and the second resistor R2. The liquid crystal capacitor Clc includes a pixel electrode PE electrically connected to a drain electrode of the thin film transistor TR, a common electrode CE opposite to the pixel electrode PE, and a liquid crystal layer (not shown) disposed between the pixel electrode PE and the common electrode CE. The liquid crystal capacitor Clc may be charged with a voltage difference between a data voltage supplied to the pixel electrode PE and the output voltage Vcom supplied to the common electrode CE. The second resistor R2 may be resistant components of the first and second common voltage lines 110 and 120 disposed in the display panel 100 but is not limited thereto. That is, the second resistor R2 may be a resistant component of the common electrode CE disposed on the display panel 100.

Also, not shown in FIG. 3, the output voltage Vcom outputted from the common voltage generator 220 may be provided to the common electrode CE disposed on the display panel 100 through the data driving unit 400. Similarly, the feedback voltage Vcom′ outputted from the display panel 100 may be provided to the common voltage generator 220 through the data driver 400.

As described with reference to FIG. 1, a conventional common voltage generator generates a compensated common voltage based on a feedback voltage including a ripple. As a result, since a distorted common voltage is provided to a common electrode of a display panel, pixels of the display panel may not display normal images.

In the embodiment, the common voltage generator 220 may generate the output voltage Vcom based on the first and second resistors R1 and R2. That is, the common voltage generator 220 may generate the output voltage Vcom referring to the second resistor R2 that is resistant components of the first and second common voltage lines 110 and 120 disposed on the display panel 100. The output voltage Vcom outputted from the amplifier 221 may be expressed as Equation 1 as follows.

$$Vcom = Vi - \frac{R 1}{R 2} * {Vcom}^{′} \qquad Equation ( 1 )$$

where Vcom is an output voltage, Vi is a reference voltage, R1 is an internal resistance of the common voltage generator, R2 is a resistance component of the common electrode CE disposed on the display panel, and Vcom′ is a feedback voltage from the output of the amplifier.

In detail, the amplifier 221 may generate the output voltage Vcom based on a non-inverting amplifier configuration as shown in Equation 1. For example, the amplifier 221 may generate the output voltage Vcom based on a ratio of the first resistor R1 disposed in the common voltage generator 220 to the second resistor R2 disposed in the display panel 100.

For example, when the amplifier 221 does not receive the feedback voltage Vcom′, the amplifier 221 outputs the output voltage Vcom based on the reference voltage Vi. That is, when the feedback voltage Vcom′ does not occur, the amplifier 221 provides the display panel 100 with the reference voltage Vi as the output voltage Vcom.

On the contrary, when the amplifier 221 receives the feedback voltage Vcom′, the amplifier 221 outputs the compensated output voltage as the output voltage Vcom based on the ratio between the first and second resistors R1 and R2. In this case, the feedback voltage Vcom′ is an AC voltage. Accordingly, the amplifier 221, in response to the modulated voltage according to the ripple, outputs the inverted modulated voltage based on the ratio between the first and second resistors R1 and R2 as the compensated first common voltage.

On the other hand, the amplifier 221 may generate the output voltage Vcom not to allow a level of the output voltage Vcom to be higher than a preset level of the positive power supply Avdd. For example, when the level of the output voltage Vcom calculated based on Equation 1 is higher than the preset level of the positive power supply Avdd, the amplifier 221 may output the positive power supply Avdd.

Also, the amplifier 221 may generate the output voltage Vcom not to allow a level of the output voltage Vcom to be lower than a level of the negative power supply, ground voltage GVD. For example, when the level of the output voltage Vcom calculated based on Equation 1 is lower than the level of the negative power supply, ground voltage GND, the amplifier 221 may output the ground voltage GND.

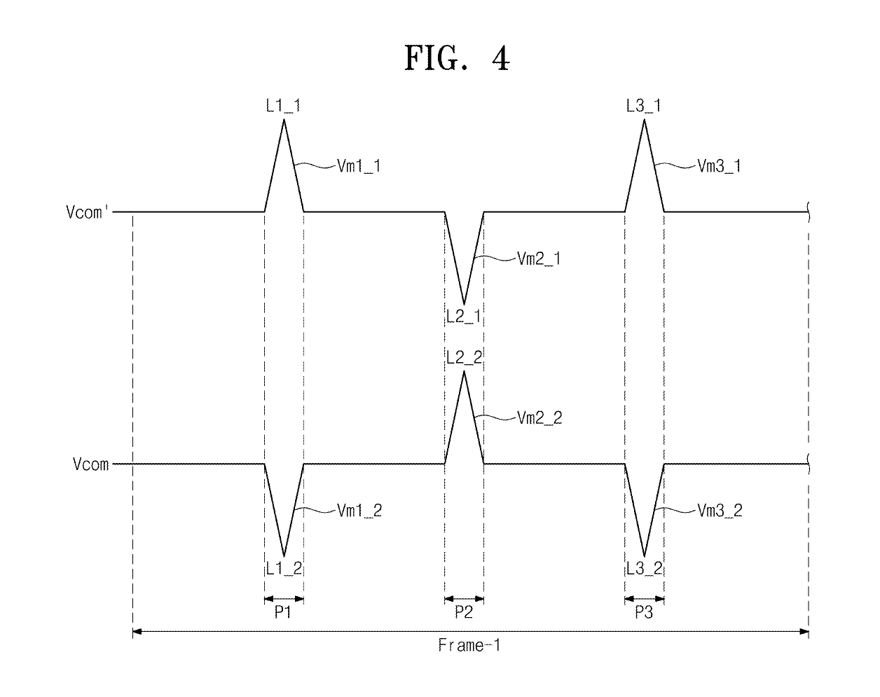

FIG. 4 illustrates an example of generating an output voltage compensated by the common voltage generator 220 shown in FIG. 3.

Referring to FIGS. 3 and 4, during a first frame Frame-1 of a plurality of frames displayed with images, the feedback voltage Vcom′ will be explained as an AC voltage.

For example, a first section P1 of the first frame-1 may have a first ripple L1_1. In this case, as the first ripple L1_1 is generated, a first modulated voltage Vm1_1 corresponding to the first ripple L1_1 may be included in the feedback voltage Vcom′. After that, the common voltage generator 220 receives the feedback voltage Vcom′ including the first modulated voltage Vm1_1 from the display panel 100. The common voltage generator 220, in response to the first modulated voltage Vm1_1, may generate a first inverse modulated voltage Vm1_2 based on the ratio between the first and second resistors R1 and R2. That is, corresponding to the first modulated voltage Vm1_1 of the first ripple L1_1, the first inverse modulated voltage Vm1_2 of a first inverse ripple L1_2 may be generated in the first section P1. Herein, the amplifier 221, in response to the preset positive power supply Avdd and the negative power supply GND, may output the first inverse modulated voltage Vm1_2.

For example, a second section P2 of the first frame-1 may be generated with a second ripple L2_1. In this case, as the second ripple L2_1 is generated, the second modulated voltage Vm2_1 corresponding to the second ripple L2_1 may be included in the feedback voltage Vcom′. After that, the common voltage generator 220 receives the feedback voltage Vcom′ including the second modulated voltage Vm2_1 from the display panel 100. The common voltage generator 220, in response to the second modulated voltage Vm2_1, may generate a second inverse modulated voltage Vm2_2 based on the ratio between the first and second resistors R1 and R2. That is, corresponding to the second modulated voltage Vm2_1 of the second ripple L2_1, the second inverse modulated voltage Vm2_2 of a second inverse ripple L2_2 may be generated in a second section P2. Herein, the amplifier 221, in response to the preset positive power supply Avdd and the negative power supply GND, may output the second inverse modulated voltage Vm2_2.

For example, a third section P3 of the first frame-1 may be generated with a third ripple L3_1. In brief, the third section P3 may be operated the same way as the first section P1. Accordingly, a repetitive description thereof will be omitted.

On the other hand, in other sections of the first frame Frame-1 in addition to the first to third sections P1, P2, and P3, a normal feedback voltage Vcom′ having the same level as the output voltage Vcom may be provided to the display panel 100. In this case, the amplifier 221 may provide the display panel 100 with the reference voltage Vi.

As described above, the common voltage generator 220 generates the output voltage Vcom including an inverse ripple for compensating a ripple. Thus, the ripple is compensated and the display qualities are improved.

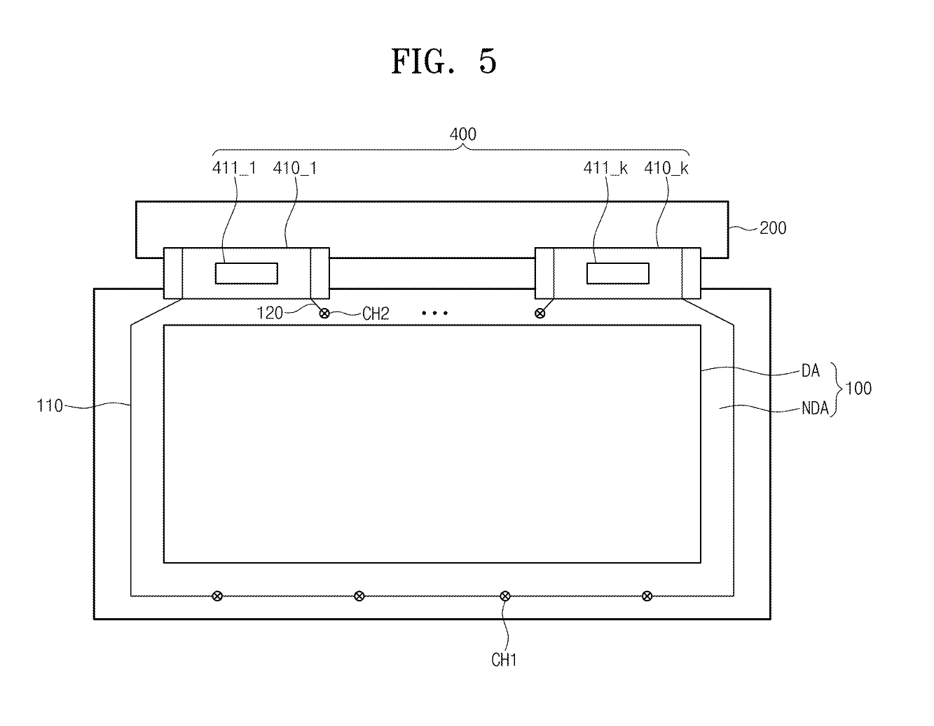

FIG. 5 is a schematic top view of the display panel 100 of FIG. 1.

Referring to FIG. 5, the display panel 100 includes the display area DA displaying images and the non-display area NDA including driving units. The flexible printed circuit board 200 includes the timing controller 210 and the common voltage generator 220.

The data driving unit 400 includes a plurality of source driving chips 411_1 to 411_{—}k. Herein, k is an integer greater than 0. The source driving chips 411_1 to 411_{—}k provide data voltages to pixels disposed in the display area DA. The source driving chips 411_1 to 411_{—}k are mounted on a plurality of flexible circuit boards 410_1 to 410_{—}k, and the flexible printed circuit boards 410_1 to 410_{—}k may be connected to the printed circuit board 400 and the non-display area NDA adjacent to a top of the display panel 100.

In detail, the first common voltage line 110 is electrically connected to the common electrode CE through the first contact hole CH1. The second common voltage line 120 is electrically connected to the common electrode CE through the second contact hole CH2.

In the embodiment, the common voltage generator 220 receives the feedback voltage Vcom′ through the first common voltage line 110 connected to the common electrode CE. Herein, the common voltage generator 220 does not receive the feedback voltage Vcom′ through the second common voltage line 120.

In the embodiment, the output voltage Vcom outputted from the common voltage generator 220 is provided to the common electrode CE through the second common voltage line 120. Herein, the common voltage generator 220 does not provide the common electrode CE with the output voltage Vcom through the first common voltage line 110.

Generally, as a first common voltage is more provided through a contact hole farther from a data driving unit, a ripple component of the output voltage may be more included in the first voltage.

Accordingly, the common voltage generator 220 receives the feedback voltage Vcom′ through at least one of the first contact hole CH1 among contact holes included in the first common voltage line 110 disposed below a boundary of the display area DA. That is, the common voltage generator 220 may receive the feedback voltage Vcom′ including the ripple through a contact hole disposed far from the data driving unit 400.

Also, the common voltage generator 220 may output the output voltage Vcom compensated with the ripple component through at least one second contact hole CH2 among contact holes included in the second common voltage lines 120 most adjacent to the data driving unit 400.

According to the embodiments, driving reliability of a display device may increase.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A display device comprising:
a display panel including a plurality of pixels; and
a common voltage generator generating an output voltage to be provided to the plurality of pixels,
wherein each of the plurality of pixels comprises:
a pixel electrode receiving a data voltage;
a common electrode receiving the output voltage through common voltage lines; and
a liquid crystal capacitor charged with a voltage difference between the data voltage and the output voltage, and
wherein the common voltage generator compensates the output voltage based on a ratio of an internal resistance of the common voltage generator to a resistance component of the common electrode disposed on the display panel and outputs the compensated output voltage.

2. The display device of claim 1, wherein the display panel outputs a feedback voltage in response to the output voltage.

3. The display device of claim 2, wherein the common voltage generator comprises:
an amplifier outputting the output voltage in response to the feedback voltage provided through a first input terminal and a reference voltage provided through a second input terminal; and
a reference voltage source providing the reference voltage, and
wherein the amplifier outputs the output voltage based on the ratio between the first and second resistors.

4. The display device of claim 3, wherein the first input terminal is an inverting input terminal and the second input terminal is a non-inverting input terminal.

5. The display device of claim 3, wherein the amplifier is a non-inverting amplifier.

6. The display device of claim 3, wherein the amplifier outputs the output voltage based on a preset positive power supply, and
wherein a level of the output voltage is identical to or lower than the positive power supply.

7. The display device of claim 3, wherein the amplifier outputs the output voltage based on a preset negative power supply, and
wherein a level of the output voltage is identical to or higher than the negative power supply.

8. The display device of claim 2, wherein the display panel comprises a display area displaying an image and a non-display area including driving units.

9. The display device of claim 8, wherein the common voltage lines comprise a first and second common voltage lines, and
wherein the first and second common voltage lines are disposed at least one in the non-display area.

10. The display device of claim 9, wherein the first common voltage lines are disposed on the non-display area in which pads for a data driving unit is disposed.

11. The display device of claim 9, wherein the second common voltage lines are disposed on the non-display area in which pads for a data driving unit is disposed and are electrically connected to one another.

12. The display device of claim 9, wherein the first common voltage line includes a plurality of contact holes electrically connecting the first common voltage line to the common electrode, and
wherein the first contact holes are disposed on the first common voltage line to be separate from one another with predetermined intervals.

13. The display device of claim 12, wherein the common voltage generator receives the feedback voltage through at least one of the first contact holes.

14. The display device of claim 9, wherein the second common voltage line includes a second contact hole electrically connecting the second common voltage line to the common electrode.

15. The display device of claim 14, wherein the common voltage generator provides the output voltage through the second contact hole.

16. The display device of claim 2, further comprising a data driving unit generating a plurality of data voltages to be provided to the plurality of pixels.

17. The display device of claim 16, wherein the data driving unit includes a common voltage node connected to the first and the second common voltage lines the display panel.

18. The display device of claim 16, further comprising a printed circuit board mounted with the common voltage generator,
wherein the printed circuit board comprises a timing controller providing the data driving unit with a data control signal for generating the data voltages and image signals converted with a data format.

19. The display device of claim 1, wherein the output voltage is determined using the following equation:
$$Vcom = Vi - \frac{R 1}{R 2} * {Vcom}^{′}$$
where Vcom is the output voltage, Vi is a reference voltage, R1 is the internal resistance of the common voltage generator, R2 is the resistance component of the common electrode disposed on the display panel, and Vcom′ is a feedback voltage from an output of an amplifier.
